(19) United States
(12) Patent Application Publication
(10) Pub. No.: US 2017/0361445 A1
(43) Pub. Date: Dec. 21, 2017

(54) ARRANGEMENT IN IMPACT UNIT

(71) Applicant: SANDVIK MINING AND CONSTRUCTION OY, Tampere (FI)

(72) Inventors: Ossi KAHRA, Tampere (FI); Juhani LAINE, Tampere (FI)

(21) Appl. No.: 15/625,134

(22) Filed: Jun. 16, 2017

(30) Foreign Application Priority Data
Jun. 17, 2016 (EP) 16174979.1

(51) Int. Cl. B25D 17/00; E21B 1/02; B25D 9/00; B25D 17/08

(52) U.S. Cl. CPC B25D 17/00; B25D 17/08; E21B 1/02; B25D 9/00; B25D 2250/051; B25D 2250/361; B25D 2250/065

(57) ABSTRACT

A body of an impact unit, an impact unit and a method of forming a body of an impact unit is disclosed. The body can be an elongated hollow piece including at least two body parts. The body parts are arranged successively in an axial direction of the body and are connected to each other by axial connecting joints. The connecting joints include several slanted fastening screws for connecting the body parts together.

### RELATED APPLICATION DATA

This application claims priority under 35 U.S.C. §119 to EP Patent Application No. 16174979.1, filed on Jun. 17, 2016, which the entirety thereof is incorporated herein by reference.

### TECHNICAL FIELD

The present disclosure relates to a body of an impact unit of a breaking hammer or rock drilling machine. The disclosure further relates to an impact unit and a method of forming a body of an impact unit.

### BACKGROUND

Breaking hammers are used to break hard materials, such as rock, concrete, and the like. The breaking hammer includes an impact device for generating impact pulses to a breaking tool connectable to the breaking hammer. The breaking hammer includes a body inside which the percussion element of the impact device is located. The current arrangements in bodies of the impact units have shown to contain some disadvantages relating to their size and weight, for example.

### SUMMARY

To overcome the above disadvantages, the present disclosure is directed to a body of an impact unit being an elongated hollow piece inside which is an inner space for arranging operable elements of the impact unit inside the body. The body includes two or more successive body parts, which are in an axial direction of the body. The body parts are provided with axial connecting surfaces for the mounting. One or more axial connecting joints are formed between the successive body parts. At the axial connecting joint axial connecting surfaces of the body parts to be connected are facing towards each other. The axial connecting surfaces are pressed towards each other by means of fastening screws.

Further, the connecting joint has fastening screws, which are slanted relative to the axial direction of the body. In other words, the body parts are fastened together by several slanted fastening screws longitudinal direction of which screws deviates from the axial direction of the body.

An advantage of the disclosed solution is that the slanting improves accessibility of the fastening screws, whereby mounting and tightening of the slanted fastening screws is easier and faster compared to conventional screws oriented parallel with the axial direction of the body. Further, the use of the slanted fastening screws allows arranging the fastening screws closer to side surfaces of the body parts. Hence, outer dimensions and weight of the successively connected body parts may be decreased. In conclusion, the disclosed solution facilitates use of several successive body parts with reasonable size and weight, and also facilitates fastening of the body parts together.

According to an embodiment, the body of an impact unit is designed and provided with means for receiving inside the body an impact device comprising an impact element such as a percussion piston. Inside the body may also be a control valve or corresponding control element, as well as a pressure accumulator. Further, the body may also receive a tool, a shank or an intermediate element for transmitting impact pulses and stress waves produced by means of the impact device. The mentioned elements of the impact device and the elements transmitting the impact pulses are operable elements, which are located inside the body of the impact unit.

According to an embodiment, the fastening screws of the axial connecting joint include first ends provided with turning heads and second end portions provided with threads. The fastening screws are slanted so that longitudinal axis of the fastenings screws are at the threaded second ends of the fastening screws closer to central axis of the body compared to their opposite first ends provided with turning heads. In other words, the turning head of the slanted fastening screw is at a greater transverse distance from the central axis than the thread end. Positioning of a tightening tool to the turning head is facilitated since the turning head is directed slightly away from side surfaces of the body part. Thus, accessibility of the turning head is improved. When the positioning of the tightening tool to the turning head is facilitated, dismounting and mounting of the body are facilitated and quickened during assembly, and also later when executing service and repair.

According to an embodiment, the elongated body of the impact unit includes a first end and a second end. An impact device is located mainly at the second end side of the body and a breaking tool connectable to the impact unit is located at the first end side of the body. The fastening screws of the axial connecting joint include first ends provided with turning heads. The turning heads of the fastening screws are facing towards the first end of the body. In other words, the turning heads are facing towards the tool side end of the body.

According to an embodiment, the turning heads of the fastening screws of the connecting joint are facing towards the second end of the body. Thus, in this embodiment the turning heads are facing towards an opposite direction relative to the previous embodiment. Typically, accessibility is better from the impact device side end.

According to an embodiment, the axial connecting joint includes one or more slanted first fastening screws and one or more slanted second fastening screws. Turning heads of the first and second fastening screws are facing towards opposing directions. Thus, the first fastening screws are facing towards the first end and the second fastening screws are facing towards the second end. This solution provides further possibilities for positioning the fastening screws.

According to an embodiment, the slanted fastening screws have an angle relative to normal of the connecting surfaces of the connecting joint. Magnitude of the angle of the slanted fastening screws is between 5-15°.

According to an embodiment, all the slanted fastenings screws of one axial connecting joint have the same angle relative to normal of the connecting surfaces of the connecting joint.

According to an embodiment, the axial connecting joint may include fastening screws with differing angles. This embodiment may be useful when space for one or more fastening screws of the connecting joint is limited. Then, one or more screws may be oriented in a slightly different angle than the other screws for improving accessibility.

According to an embodiment, the connecting joint includes flat support surfaces, which are located at screw holes of the slanted fastening screws. The flat support surfaces are located on opposite sides relative to axial connecting surface of the body part. The support surfaces are perpendicular relative to longitudinal axis of the fastening screws. Then, support surfaces of turning heads of the fastening screws are pressed against correspondingly orientated support surfaces when the fastening screws are tightened. In other words, the support surfaces facing towards each other at the fastening screws are flat and are slanted in accordance with the slanting angle of the fastening screws. This way, flat bottoms of the turning heads are pressed tightly against flat support surfaces at the connecting joint. Thanks to the flat support surface, formation of line-shaped contact area between the turning head and the support surface is avoided.

According to an embodiment, the fastening screws include turning heads provided with flat first support surfaces facing towards the connecting joint. The connecting joint includes a support flange on a side of the turning heads and the support flange is provided with openings through which the fastening screws pass. The support flange is provided with several flat second support surfaces at the screw openings. The flat second surfaces are facing towards the flat support surfaces on the bottom of the turning heads of the screws. The mating flat support surfaces located at the screw openings are perpendicular relative to longitudinal axis of the slanted fastening screws. In other words, the mating flat support surfaces are slanted relative to the central axis of the body. When the fastening screws are tightened, the slanted flat support surfaces are pressed properly against each other and size of a contact area between the turning head and the support flange large enough to transmit generated fastening forces.

According to an embodiment, the connecting joint includes a first support flange, which is located at one end of a body part and is provided with an annular first connecting surface facing towards another body part. The first support flange includes an annular supplementary surface on an opposite side of the first support flange relative to the connecting surface. The annular supplementary surface of the first support flange is slanted relative to a line perpendicular to an axial center line of the body. Further, the slanted annular supplementary surface is provided with several flat second support surfaces facing towards flat bottoms of the heads of the fastening screws. This kind of local flat second support surfaces may be machined by milling for example.

According to an embodiment, the connecting joint includes a first support flange, which is located at one end of a body part and is provided with an annular first connecting surface facing towards another body part. The support flange is provided with openings through which the fastening screws pass. Further, the first support flange is provided with recesses located at the screw holes. The recesses are dimensioned to receive screw heads of the fastening screws. Bottoms of the recesses are slanted in accordance to orientation of the slanted fastening screws. The recesses may be machined by a milling tool or a broaching drill easily and accurately.

According to an embodiment, inside the hollow body of an impact unit is an impact device for generating impact pulses in an impact direction. The impact device may include a percussion piston or corresponding mechanical and axially directed impact element, which is configured to be moved to and fro in the axial direction inside the connecting joint during the use of the impact unit. Further, the body is provided with coupling means at an impact end of the body for connecting a changeable tool to the impact device. The tool is located on the central axis of the body and is configured to receive the impact pulses generated by means of the impact device.

According to an embodiment, the body of the impact unit and the disclosed features of the connecting joints and connecting means are implemented in a breaking hammer.

According to an embodiment, the body of the impact unit and the disclosed features of the connecting joints and connecting means are implemented in a rock drilling machine.

According to an embodiment, the connecting joint includes only two hollow body parts connected to each other by means of the common fastening screws.

According to an embodiment, the connecting joint may include three or more body parts connected to each other by means of the common fastening screws. Thus, an intermediate flange, sealing flange or corresponding element may be arranged between two hollow main body parts.

According to an embodiment, the body includes three or more body parts and at least two connecting joints.

According to an embodiment, all fastening screws of the connecting joint are slanted.

According to an embodiment, at least one fastening flange of the connecting joint is round shaped.

According to an embodiment, at least one fastening flange of the connecting joint has a rectangular shape.

According to an embodiment, at least one body part may include a fastening flange provided with a round outer surface and an axial surface serving as the connecting surface. The fastening flange is further provided with several screw holes through which the fastening screws are mountable. The screw holes are located on a pitch diameter. Magnitude of the pitch diameter is less than product of the following formula 1,3 * magnitude of an outer diameter of the body part. The magnitude of the pitch diameter is examined at an intersection point between a bottom surface of a turning head of the fastening screw and a longitudinal axis of the fastening screw. Thanks to this embodiment, the fastening screws are located relatively close to outer side surfaces of the body part.

According to an embodiment, the connecting joint between the body parts may be without any separate sealing element. Further, no continuous fluid flow is lead between the connected body parts through the connecting joint at a portion defined by the inner spaces of the connecting joint. Moreover, a mechanical and axially directed component is configured to be moved to and fro in the axial direction inside the connecting joint during the use of the impact unit.

According to an embodiment, the disclosed connecting joint of the body is not rotated around the longitudinal axis during the operation of the impact unit. The bodies of breaking hammers and rock drilling machines are supported to their mounting structures preventing their rotation.

According to an embodiment, at least one connecting joint may include at least one axial channel between inner and outer surfaces of the coupled body parts. The inner surface is defined by a central axial hollow space of the body part. The axial channel may be a lubrication channel, for example.

According to an embodiment, the body includes a first end body part at the second end of the body. The first end body part serves as an end cover for the impact unit.

According to an embodiment at least one body part of at least one connecting joint of the body includes at least one pressure medium space.

According to an embodiment at least one body part of at least one connecting joint of the body includes a pressure accumulator.

According to an embodiment at least one body part of at least one connecting joint of the body includes a flushing housing. This embodiment relates to a rock drilling machine, which utilized flushing.

According to an embodiment, number of the fastening screws at each connecting joint is between 8-36.

According to an embodiment, diameter of the fastening bolts is between 12-36 mm.

According to an embodiment, the body has two or more connecting joints and the magnitude of the angle of the fastening screws is the same in all connecting joints.

According to an embodiment, the body has two or more connecting joints and the magnitude of the angle of the fastening screws is different in the connecting joints.

The axial connecting surface relates to a surface, which is perpendicular relative to the longitudinal direction of the body. In addition to a perpendicular flat surface portion, the axial connecting surface may have guide surfaces, such as a longitudinally protruding section provided with radial guide surfaces.

Let it be mentioned, that the mounting principles and means disclosed above are also suitable for other types of breaking hammers and impact units than those disclosed in this patent application. The percussion or impact device may differ from the one shown, for example.

The above-disclosed embodiments can be combined to form desired solutions provided with necessary features disclosed.

### BRIEF DESCRIPTION OF THE DRAWINGS

FIG. 1 is a schematic and sectional side view of a breaking hammer, which is provided with an impact device arranged inside a longitudinal body.

FIG. 2 is a schematic and sectional side view of an alternative body of a breaking hammer,

FIGS. 3-5 are schematic and sectional side views of some feasible axial connecting joints,

FIG. 6 is a schematic and partly sectional axial view of a body part provided with a support flange and flat support surfaces located at screw holes,

FIG. 7 is a schematic axial view of a rectangular support flange of a body part,

FIG. 8 is a schematic side view of the rectangular flange shown in FIG. 7, and

FIG. 9 is a schematic side view of a fastening screw.

For the sake of clarity, the Figures show some embodiments of the disclosed solution in a simplified manner. In the Figures, like reference numerals identify like elements.

The foregoing summary, as well as the following detailed description of the embodiments, will be better understood when read in conjunction with the appended drawings. It should be understood that the embodiments depicted are not limited to the precise arrangements and instrumentalities shown.

### DETAILED DESCRIPTION OF SOME EMBODIMENTS

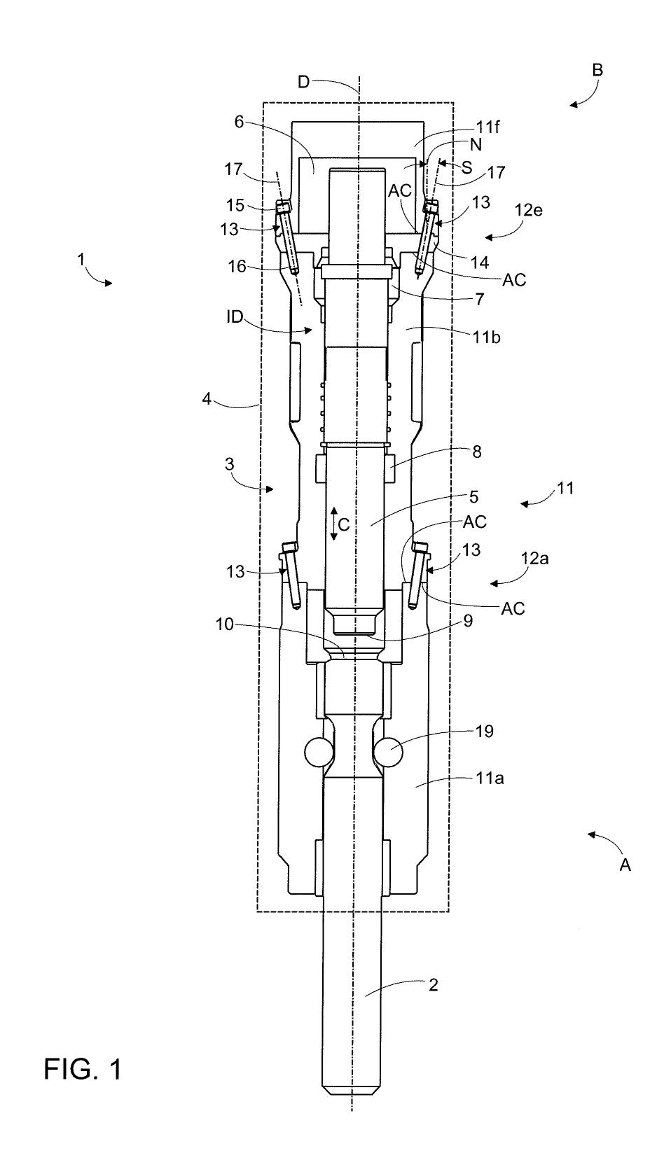

FIG. 1 discloses a basic structure of a breaking hammer 1. The breaking hammer 1 includes a first end A, or front end, at a tool 2 side end, and a second end B, or rear end, at the opposite end. At the second end B may be mounting means for connecting the breaking hammer 1 to a boom of working machine. The breaking hammer 1 includes an elongated body 3. The body 3 may be surrounded by means of a protective casing 4. The body 3 is a hollow structure, whereby it is provided with an inner space for receiving an impact device ID inside the body 3. The impact device ID may include a percussion piston 5 and a pressure accumulator 6. The percussion piston 5 is arranged to move longitudinally C to and fro relative to the body 3 by directing pressurized fluid to working pressure spaces 7, 8 inside the body. Transverse fluid channels FC may open to inner surfaces defining the pressure spaces. An impact surface 9 of the percussion piston 5 is arranged to strike an upper end 10 of the breaking tool 2. Thus, inside the body 3 are located operable elements of the impact unit for generating impact pulses to the tool 2.

In FIG. 1 the body 3 includes three body parts 11 instead of one single uniform body structure. A first main body part 11a is located at the first end A side of the body 3 and a second main body part 11b is connected to a rear end of the first main body part 11a. Further, an end body part 11f is connected to a rear end of the second body part 11b. The body parts 11a, 11b, 11f are arranged successively in axial direction of the body 3. Between the first body part 11a and the second body part 11b is a first axial connecting joint 12a and between the second body part 11b and the end body part 11f is a rear axial connecting joint 12e. At the axial connecting joint 12a axial connecting surfaces AC of the first body part 11a and 11b are pressed against each other by means of several fastening screws 13. At the rear axial connecting joint 12e connecting surfaces AC of the second body part 11b and the end body part 11f are pressed towards each other by means of fastening screws 13. At the rear axial connecting joint 12e there may be an intermediate element 14 between the body parts 11b and 11f. Inside the end body part 11f may be a pressure accumulator for storing pressurized fluid to an inner space of the body part. The rear end of the percussion piston 5 may be located inside the end body part 11f and the front end of the piston 5 may extend to an inner space of the first body part 11a.

As it is disclosed in FIG. 1, the fastening screws 13 are slanted relative to central axis D of the body 3. The fastening screw 13 may include a turning head 15 at one end of the screw and a thread end 16 at an opposite end. In FIG. 1 the fastenings screws 13 of both axial connecting joints 12a and 12e are oriented so that the turning heads 15 are facing towards the second end B, i.e. rear end of the breaking hammer 1. Further, longitudinal axis 17 of the fastening screws 13 are at the turning heads 15 at a greater transverse direction from the central axis D than at the thread end 16. The fastening screw 13 has a slanting angle S between the longitudinal axis 17 and normal line N of the axial connecting surface AC. FIG. 1 further shows that slanting angle of the fastening screws 13 of the axial connecting joints 12a and 12e may be slightly different.

The percussion piston 5 extends over the axial connecting joints 12a, 12e and moves in the axial direction relative to the axial connecting joints. Further, the first body part 11a may include one or more transverse connecting pins 19 for connecting the breaking tool 6 to the first body part 11a.

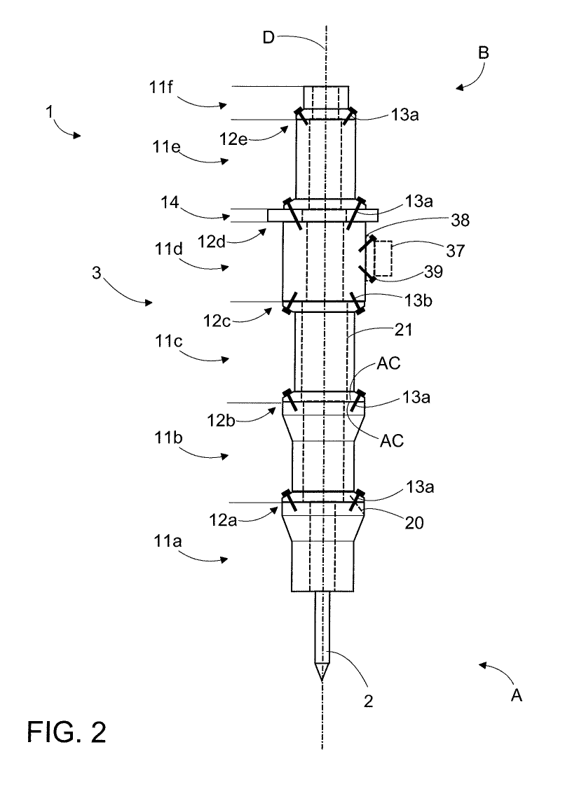

FIG. 2 discloses a breaking hammer 1 provided with a body 3, which includes six successively arranged body parts 11a-11f. Between the body parts are axial connection joints 12a-12e for connecting opposing axial connection surfaces AC of the body parts together. The axial connecting joints 12a-12e may include fastening screws 13a, 13b, which are slanted relative to the central axis D of the body 3. Turning heads 15 of first fastening screws 13a are facing towards the second end B of the body 3 and turning heads 15 of the second fastening screws 13b are facing towards the first end A of the body. Thus, the body 3 may include axial connecting joints having differently orientated slanted fastening screws 13a, 13b. In the first axial connection joint 12a it is further illustrated by means of a broken line 20, that there may be fastening screws having opposing orientation in one single axial connecting joint. Further, broken lines 21 indicate inner surfaces of the hollow body parts 11a-11f.

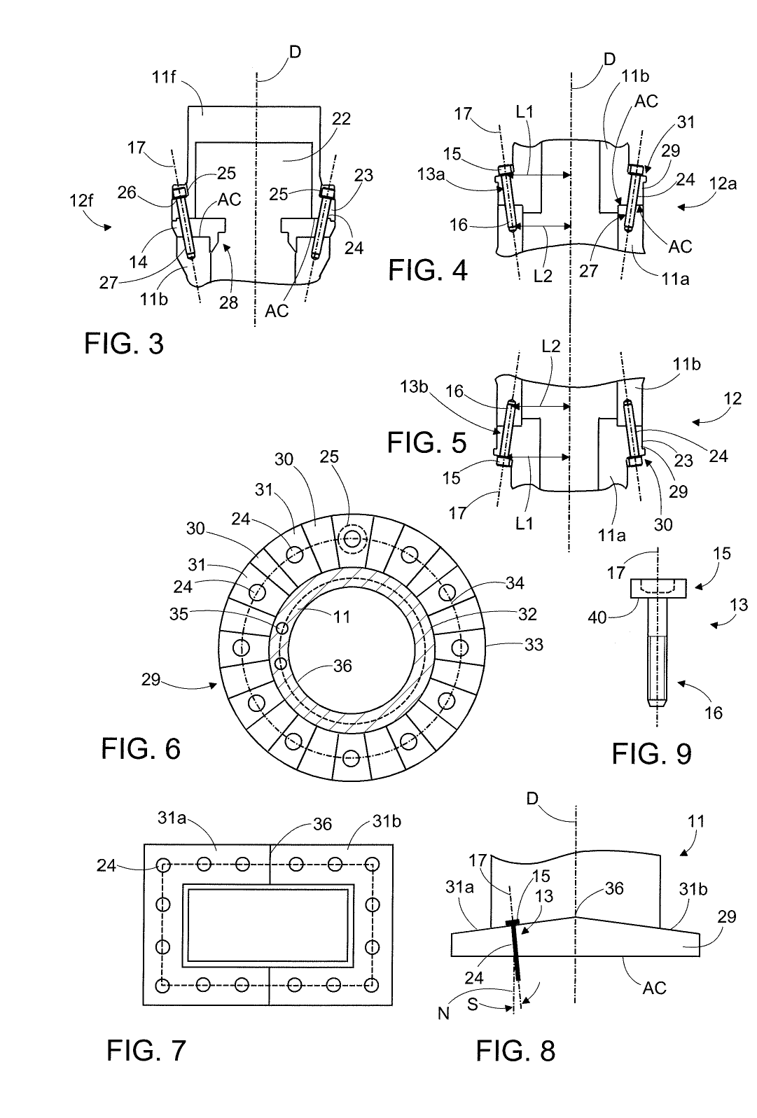

FIG. 3 discloses in more detailed the rear axial connecting joint 12e of the body 3 disclosed in FIG. 1. The end body part 11f may have a pressure space 22, and it may also serve as an end cover for the body 3. The end body part 11f includes a support flange 23 provided with screw holes 24 for the fastening screws 13. The support flange 23 further includes several recesses 25, which are located at the screw holes 24 and are dimensioned to receive turning heads 15 of fastening screws 13. Bottoms 26 of the recesses 25 are flat and they are orientated perpendicularly relative to the longitudinal axis 17 of the fastening screws 13. Thereby, the bottoms 26 are slanted so that they match with bottom surfaces of the turning heads 15 of the slanted fastening screws 13. The second body part 11b includes several threaded blind holes 27 for receiving the thread ends 16 of the fastening screws 13. Naturally, the blind holes 27 must have the same slanting direction as the fastening screws 13 and the screw holes 24. Further, the intermediate element 14 may be a substantially disc shaped piece and it may be provided with control surfaces 28 or edges on its inner surface side. The intermediate element 14 may also be provided with sealing elements, whereby axial connecting surfaces AC of the body parts 11b and 11f may be without any sealing means.

FIG. 4 discloses in more detailed the first axial connecting joint 12a of the body 3 disclosed in FIG. 1. The second body part 11b includes a support flange 29 provided with flat second support surfaces 31. The support flange 29 includes several screw holes 24 through which slanted fastening screws 13a are arranged. Turning heads 15 of the fastening screws 13a are located on the side of the second body part 11b and the first body part is provided with threaded blind holes 27. Longitudinal axis 17 of the fastening screws 13a are located at bottoms of the turning heads 15 at a first distance L1 from the central axis D of the body, and at the thread end 16 at a shorter second distance L2.

FIG. 5 discloses an alternative connecting joint 12 to the one disclosed in FIG. 4. The basic structure and features correspond to the axial connection joint 12a disclosed in FIG. 4. However, the support flange 29 is part of the first body part 11a and the turning heads 15 of the fastening screws 13b are on the first end A side of the body. Centers of bottoms of the turning heads 15 are located at a greater first distance L1 from the central axis D compared to the thread ends 16. In other words, the first distance L1 is examined at an intersection point between a bottom surface of the turning head 15 and a longitudinal axis 17 of the fastening screw 13, and the second distance L2 is examined at an intersection point between the longitudinal axis 17 and an outermost end of the fastening screw 13.

FIG. 6 discloses a support flange 29, which is located at a first end of a body part 11. The support flange includes an annular supplementary surface 30, which is slanted and is facing towards the second end of the body part 11. On an opposite side of the supplementary surface side is an annular connecting surface facing towards another body part. The annular supplementary surface 30 is provided with several flat second support surfaces 31 at screw holes 24. The flat second support surfaces 31 may extend from an outer circumference 32 of a body part 11 to an outer circumference 33 of the support flange 29. As can be noted, the surfaces 30 and 31 may alternate on the support flange 29. An alternative to the flat second support surfaces 31 is to form recesses 25 with flat bottoms at the screw holes 24, as it is disclosed above in this patent application. The screw holes 24 are located on a pitch diameter 34. Due to the slanted fastening screws, the pitch diameter 34 may be dimensioned to be relatively small compared to diameter of the outer circumference 32 of the body part 11. This way, diameter of an outer circumference 33 of the support flange 29 may be relatively small. In FIG. 6 the size of the support flange 29 is exaggerated in order to improve clarity. FIG. 6 further discloses that the body part 11 may include one or more axial fluid channels 35 between an inner circumference 36 and the outer circumference 32.

FIGS. 7 and 8 disclose a rectangular support flange 29 of a body part 11. The support flange 29 includes two flat support surface portions 31a and 31b, which have differing orientation. The support surfaces 31a and 31b are slanted relative to the central axis D of the body. A division line 36 is formed between the differently slanted surfaces 31a, 31b and it is located at the central axis D. FIG. 8 shows that the slanted support surface 31a matches with a bottom of a turning head 15 of a slanted fastening screw 13. Slanting angle of the surfaces 31a, 31b are selected in accordance with a slanting angle S of the fastening screw 13.

FIG. 9 further discloses a fastening screw 13 comprising a turning head 15 at a first end and threads 16 at a second end portion. At a bottom of the turning head 15 is a flat first support surface 40, which may be pressed against a flat second support surface as it is disclosed above.

Further, an alternative solution relates to a body of an impact unit having one or more connecting joints in a transverse direction to the longitudinal axis of the body. In other words, the connecting joint connects two body parts in another direction than in the axial direction of the body of the impact unit. This kind of connection joint may connect a body part of a pressure accumulator or a valve arrangement to the main body of the impact unit. The transverse connecting joint may have one or more slanted fastening screws in accordance to all the features disclosed in this patent application. This alternative solution is disclosed in FIG. 2, wherein the transversal body part 37, the transversal connecting joint 38 between the body 3 and the transversal element 37 is shown together with the transversal slanted fastening screws 39.

Although the present embodiment(s) has been described in relation to particular aspects thereof, many other variations and modifications and other uses will become apparent to those skilled in the art. It is preferred therefore, that the present embodiment(s) be limited not by the specific disclosure herein, but only by the appended claims.

1. A body of an impact unit, comprising:
an elongated hollow piece having a first end and a second end and an inner space inside which operable elements of an impact unit are mountable;
at least two body parts arranged successively in an axial direction of the body, each of the body parts having axial connecting surfaces; and
an axial connecting joint disposed between the at least two successive body parts, the connecting joint including a plurality of fastening screws, wherein the connecting surfaces of the body parts face towards each other and are pressed towards each other by the fastening screws, wherein the fastening screws are slanted relative to an axial direction of the body.

2. The body as claimed in claim 1, wherein the fastening screws have first end portions provided with turning heads and second end portions provided with threads, wherein the fastening screws are slanted so that longitudinal axes of the fastenings screws are at the threaded second end portions, the second end portions being closer to a central axis of the body then the first end portions provided with the turning heads.

3. The body as claimed in claim 2, wherein the turning heads of the fastening screws of the connecting joint face towards the second end of the body.

4. The body as claimed in claim 2, wherein the turning heads of the fastening screws of the connecting joint face towards the first end of the body.

5. The body as claimed in claim 2, wherein the connecting joint includes at least one first fastening screw facing towards the first end and at least one second fastening screw facing towards the second end.

6. The body as claimed in claim 2, wherein the fastening screws each have an angle relative to a normal of the axial connecting surfaces of the connecting joint, a magnitude of the angle being between 5-15°.

7. The body as claimed in claim 1, wherein the fastening screws include turning heads provided with flat first support surfaces facing towards the axial connecting joint, the axial connecting joint including a support flange on a side of the turning heads, the support flange being provided with openings through which the fastening screws pass, the connecting joint having several flat second support surfaces located at the openings, the flat second surfaces are facing towards the flat first support surfaces of the fastening screws, and wherein the flat first support surfaces and the flat second support surfaces are perpendicular relative to the longitudinal axis of the slanted fastening screws, the flat first support surfaces and the flat second support surfaces being pressed against each other when the fastening screws are tightened.

8. The body as claimed in claim 7, wherein the connecting joint includes a first support flange located at one end of the body part and being provided with an annular first connecting surface facing towards another body part, the first support flange having an annular supplementary surface located on an opposite side of the first support flange, the annular supplementary surface of the first support flange being slanted relative to a line perpendicular to an axial center line of the body, and wherein the slanted annular supplementary surface is provided with several flat second support surfaces for supporting the turning heads of the fastening screws.

9. An impact unit comprising:
a body;
an impact device located inside the body; and
a coupling means device disposed at one end of the body and arranged to connect a tool to the impact unit, the body being an elongated hollow piece having a first end and a second end and an inner space inside which operable elements of an impact unit are mountable, at least two body parts arranged successively in an axial direction of the body, each of the body parts having axial connecting surfaces, and an axial connecting joint disposed between the at least two successive body parts, the connecting joint including a plurality of fastening screws, wherein the connecting surfaces of the body parts face towards each other and are pressed towards each other by the fastening screws, wherein the fastening screws are slanted relative to an axial direction of the body.

10. The impact unit as claimed in claim 9, wherein the impact unit is implemented in a breaking hammer.

11. The impact unit as claimed in claim 9, wherein the impact unit is implemented in a rock drilling machine.

12. A method of forming a body of an impact unit, the method comprising:
forming at least two separate elongated hollow body parts;
providing the body parts with axial connecting surfaces;
arranging the body parts axially successively; and
pressing the axial connecting surfaces of the body parts towards each other and fastening the body parts together by several slanted fastening screws, wherein a direction of the slanted fastening screws deviates from axial direction of the body.
